(19) United States
(12) Patent Application Publication
(10) Pub. No.: US 2026/0279243 A1
(43) Pub. Date: Sep. 17, 2026

(54) GRADATION ADJUSTMENT METHOD AND ELECTRONIC DEVICE

(71) Applicant: Honor Device Co., Ltd., Shenzhen (CN)

(72) Inventors: Xixi Zhou, Shenzhen (CN); Yong Li, Shenzhen (CN); Zhongyang Zhao, Shenzhen (CN)

(21) Appl. No.: 19/683,350

(22) Filed: May 20, 2026

Related U.S. Application Data
(63) Continuation of application No. PCT/CN2024/080700, filed on Mar. 8, 2024.

(30) Foreign Application Priority Data
Nov. 22, 2023 (CN) 202311557962.2

(51) Int. Cl. G09G 3/20; G09G 3/36

(52) U.S. Cl. CPC G09G 3/2007; G09G 3/36; G09G 2320/0247; G09G 2320/0271; G09G 2320/0686; G09G 2320/08; G09G 2330/021; G09G 2354/00

(57) ABSTRACT

This application discloses a gradation adjustment method and an electronic device, and relates to the field of display technologies. The method includes: displaying a first window of a first application at a first moment, where a gradation of the electronic device at the first moment is a first gradation; and displaying a second window of a second application at a second moment in response to a first window switching operation input by a user, where the gradation of the electronic device changes to a second gradation after the second window is displayed, and the second gradation is lower than the first gradation. The gradation of the electronic device changes to the first gradation at a third moment that is first duration after the second moment.

### CROSS-REFERENCE TO RELATED APPLICATIONS

This application is a continuation of International Application No. PCT/CN2024/080700, filed on March 8, 2024, which claims priority to Chinese Patent Application No. 202311557962.2, filed on November 22, 2023, both of which are incorporated herein by reference in their entireties.

### TECHNICAL FIELD

This application relates to the field of display technologies, and in particular, to a gradation adjustment method and an electronic device.

### BACKGROUND

A display screen is one of hardware that consumes the most power in an electronic device. To reduce the power consumed by the display screen, a display power saving technology (DPST) emerges.

The DPST is a technology for reducing power consumed by a display screen by adjusting a gradation level. Specifically, the electronic device may adjust lightness of a displayed or to-be-displayed image based on a set gradation level by using a brightness compensation algorithm, to cause adjusted lightness of the image to match backlight brightness. A higher gradation level indicates lower power consumption, more brightness compensation required, and longer computation time of the brightness compensation algorithm.

Usually, the electronic device fixedly sets a gradation level to level 3. To save more power, the gradation level may be fixedly set to level 6. However, if the gradation level is fixedly set to level 6, a user may perceive obvious brightness flicker during interface switching because the computation time of the brightness compensation algorithm is longer.

### SUMMARY

This application provides a gradation adjustment method and an electronic device, to resolve a problem of brightness flicker during interface switching, and minimize power consumed by a display screen.

According to a first aspect, this application provides a gradation adjustment method. The method is applied to an electronic device, and includes: displaying a first window of a first application at a first moment, where a gradation of the electronic device at the first moment is a first gradation; and displaying a second window of a second application at a second moment in response to a first window switching operation input by a user, where after the second window is displayed, the gradation of the electronic device changes to a second gradation, and the second gradation is lower than the first gradation. The gradation of the electronic device changes to the first gradation at a third moment that is first duration after the second moment.

In this way, after a window of the electronic device is switched from the first window to the second window, the gradation of the electronic device first changes to the second gradation at a low gradation level, and then is adjusted from the second gradation to the first gradation at a high gradation level. In this way, the gradation first changes to the second gradation at a lower gradation level, to avoid brightness flicker after a window changes. In addition, the second gradation is adjusted to a first gradation at a higher gradation level, so that the electronic device can remain at a relatively high gradation level after the second window is stabilized, to minimize power consumed by a display screen.

In an implementation, at the first moment, the first window is a focus window; and at the second moment, the focus window changes from the first window to the second window.

In an implementation, the method further includes: adjusting the gradation of the electronic device to the second gradation based on a change of the focus window after the second moment.

In this way, the gradation of the electronic device is adjusted to the second gradation provided that a focus window change occurs, to ensure that no brightness flicker occurs during focus window switching each time.

In an implementation, that the gradation of the electronic device changes to the first gradation at the third moment that is first duration after the second moment includes: The gradation of the electronic device changes to a third gradation at second duration after the second moment, where the third gradation is lower than the first gradation and higher than the second gradation, and the second duration is shorter than the first duration; and the gradation of the electronic device changes to a fourth gradation within third duration after the second moment, where the fourth gradation is lower than the first gradation and higher than the third gradation, and the third duration is longer than the second duration and shorter than the first duration.

In this way, the gradation of the electronic device may be adjusted from the second gradation at a low level to the first gradation at a high gradation level in a manner of adjusting the gradation level stepwise. In this way, stability of display brightness during gradation adjustment can be ensured.

In an implementation, changing the gradation of the electronic device to the third gradation within the second duration after the second moment includes: setting a first timer after the second moment, where the first timer is configured to count stability duration of the focus window; and obtaining a first current gradation of the electronic device when elapsed time of the first timer reaches preset stability duration, where the first current gradation is the second gradation; adjusting the gradation of the electronic device to the third gradation if the first current gradation is lower than the first gradation.

In an implementation, before setting the first timer, the method further includes: if there is a running first timer after the second moment, stopping the running first timer.

In this way, a process of adjusting the second gradation to the first gradation may be performed after the second window is stable by setting the first timer. If a new window change is detected within the preset stability duration, the running first timer may be stopped, and the first timer is re-set to restart counting of the preset stability duration. In this way, a gradation adjustment process based on a previous focus window change may be interrupted promptly.

In an implementation, changing the gradation of the electronic device to the fourth gradation within the third duration after the second moment includes: setting a DPST characteristic parameter to a first parameter after the second moment; and setting a first timer, where the first timer is configured to count stability duration of the focus window; setting the DPST characteristic parameter to a second parameter when elapsed time of the first timer reaches preset stability duration; obtaining a first current gradation of the electronic device, where the first current gradation is the second gradation; adjusting the second gradation to the third gradation if the first current gradation is lower than the first gradation; obtaining a second current gradation of the electronic device when the DPST characteristic parameter is the second parameter after the second gradation is adjusted to the third gradation, where the second current gradation is the third gradation; and adjusting the third gradation of the electronic device to the fourth gradation if the second current gradation is lower than the first gradation.

In this way, if a new window change occurs during adjustment of the gradation stepwise, gradation adjustment of a previous focus window change may be interrupted promptly based on a change of the DPST characteristic parameter.

In an implementation, after adjusting the second gradation to the third gradation, the method further includes: setting a second timer if the DPST characteristic parameter is the second parameter, where the second timer is configured to count a preset cycle time interval; and obtaining the second current gradation if elapsed time of the second timer reaches the preset cycle time interval and no focus window change notification is detected within the preset cycle time interval, where the focus window change notification is used for provide notification about the change of the focus window.

In this way, if a new window change occurs within the preset cycle time interval, gradation adjustment of a previous focus window change may be interrupted promptly based on the focus window change notification.

In an implementation, the method further includes: displaying a third window at the fourth moment in response to a second window switching operation input by the user; changing the gradation of the electronic device to the second gradation after the third window is displayed, where the fourth moment is later than the third moment; changing the gradation of the electronic device to the third gradation within the second duration after the fourth moment, where the third gradation is lower than the first gradation and higher than the second gradation; after the gradation of the electronic device changes to the third gradation, in response to a third window switching operation input by the user, displaying the fourth window at the fifth moment; and changing the gradation of the electronic device to the second gradation after the fourth window is displayed.

In this way, when the second window is switched to the third window and the third window is switched to the fourth window, the gradation of the electronic device changes to the second gradation again.

In an implementation, at the fourth moment, the third window is a focus window; at the fifth moment, the focus window changes from the third window to the fourth window; and the gradation of the electronic device is adjusted to the second gradation based on a change of the focus window.

In an implementation, the method further includes: setting a second timer after the gradation of the electronic device changes to the third gradation, where the second timer is configured to count a preset cycle time interval; displaying the fourth window at the fifth moment within the preset cycle time interval in response to the third window switching operation input by the user; generating a window change notification after the fifth moment; and ending, based on the window change notification, continuing to adjust a gradation of the third gradation.

In this way, after the gradation changes to the third gradation, a new window change occurs within the preset cycle time interval, and gradation adjustment based on a previous focus window change may be interrupted promptly based on the focus window change notification.

In an implementation, adjusting the gradation of the electronic device to the second gradation based on the change of the focus window after the second moment includes: adjusting the gradation of the electronic device to the second gradation based on the change of the focus window and a fact that a power supply mode of the electronic device is a direct current power supply after the second moment.

In an implementation, the method further includes: adjusting the gradation of the electronic device to the second gradation if a sleep exit event or a power-on event is detected.

According to a second aspect, this application further provides an electronic device. The electronic device includes a memory and a processor. The memory is coupled to the processor, the memory is configured to store computer program code, the computer program code includes computer instructions, and when the processor executes the computer instructions, the electronic device is to perform the method in any one of the first aspect.

According to a third aspect, this application further provides a computer-readable storage medium. The computer-readable storage medium stores a computer program or instructions, and when the computer program or the instructions are run on a computer, the computer is caused to perform the method in any one of the first aspect.

### BRIEF DESCRIPTION OF THE DRAWINGS

FIG. 1 is a diagram of a structure of a display screen according to an embodiment of this application;

FIG. 2 is a diagram of a hardware structure of an electronic device according to an embodiment of this application;

FIG. 3 is a diagram of a software architecture of an electronic device according to an embodiment of this application;

FIG. 4 is a diagram of software interaction in a gradation adjustment method according to an embodiment of this application;

FIG. 5 is a diagram of a gradation change based on FIG. 4 according to an embodiment of this application;

FIG. 6 is a diagram of software interaction in another gradation adjustment method according to an embodiment of this application;

FIG. 7 is a diagram of a gradation change based on FIG. 6 according to an embodiment of this application;

FIG. 8 is a diagram of software interaction in another gradation adjustment method according to an embodiment of this application;

FIG. 9 is a diagram of a gradation change based on FIG. 8 according to an embodiment of this application;

FIG. 10 is a diagram of software interaction in another gradation adjustment method according to an embodiment of this application;

FIG. 11 is a diagram of a gradation change based on FIG. 10 according to an embodiment of this application;

FIG. 12 is a diagram of software interaction in another gradation adjustment method according to an embodiment of this application;

FIG. 13 is a flowchart of another gradation adjustment method according to an embodiment of this application;

FIG. 14 is a diagram of a gradation change based on FIG. 13 according to an embodiment of this application; and

FIG. 15 is a diagram of a gradation level change read by using a tool PowerMax.

### DETAILED DESCRIPTION OF THE ILLUSTRATIVE EMBODIMENTS

For ease of understanding of technical solutions of this application, some concepts involved in this application are first described below.

A focus window is a window that has focus. Only the focus window can receive a keyboard input. The determining of the focus window is associated with a focus mode of a system. A top-layer window of the focus window is referred to as an active window. Only one window can be the active window at a time. The focus window is most likely a window that a user needs to use currently.

For example, the focus window may be a front-most window that is presented on an electronic device and that a user can directly operate. When the electronic device displays a first window (or referred to as a first interface), the focus window may correspond to the first window. When the electronic device displays a second window (or referred to as a second interface), the focus window may correspond to the second window.

The focus mode may be used for determining how a mouse causes a window to gain focus. Generally, there may be three focus modes, which are respectively described as follows.

(1) Click-to-focus. In this mode, a window can gain focus by clicking with a mouse. To be specific, when any position in a focusable window is clicked with the mouse, the window can be activated, and the window is placed in front of all windows and can receive a keyboard input. The window loses focus when another window is clicked with the mouse.

(2) Focus-follow-mouse. In this mode, a window under a mouse pointer can gain focus. To be specific, when the mouse moves into a range of a focusable window, a user may activate the window to receive a keyboard input without clicking anywhere of the window, and the window is not necessarily placed in front of all windows. When the mouse moves out of the range of the window, the window loses focus accordingly.

(3) Sloppy focus. This focus mode is similar to the focus-follow-mouse mode. When a mouse moves into a range of a focusable window, a user can activate the window to receive a keyboard input without clicking anywhere of the window, and the window is not necessarily placed in front of all windows. A difference from the focus-follow-mouse mode lies in that, when the mouse moves out of the range of the window, the focus does not change accordingly. The system focus changes only when the mouse moves to another focusable window.

A display screen is one of hardware that consumes the most power in an electronic device. According to statistics, in common use, the display screen consumes nearly one third of power of the electronic device. To reduce the power consumed by the display screen, a display power saving technology (DPST) emerges.

The following describes the DPST by using a liquid crystal display (LCD) as an example.

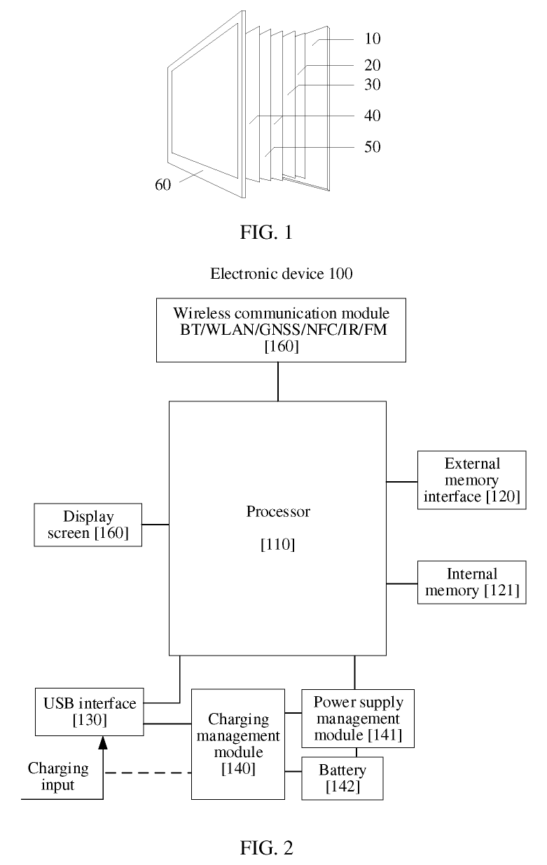

FIG. 1 is a diagram of a structure of an LCD according to an embodiment of this application. As shown in FIG. 1, the LCD includes a circuit layer 10, a backlight layer 20, a liquid crystal layer 30, a polarization unit 40, a color filter 50, and a surface layer 60 that are sequentially arranged.

The circuit layer 10 may supply power to the backlight layer 20, to cause the backlight layer 20 to emit uniform white light. The liquid crystal layer 30 deflects light based on a color and brightness information of each point. Because different light of three primary colors have different deflection rates, final colors at different points are affected. It may be learned that a part that actually emits light in the LCD is the backlight layer 20. In other words, the backlight layer 20 is a most power-consuming part in the LCD. Higher backlight brightness provided by the backlight layer 20 indicates higher power consumption of the LCD. Therefore, power consumption of the LCD can be reduced by lowering the backlight brightness of the backlight layer 20. The liquid crystal layer 30 is actually a dissipation layer, and may deflect and shield light via the color filter 50 and the polarization unit 40.

It should be understood that lower backlight brightness indicates lower power consumption of the LCD, but an overall image displayed becomes darker. However, the DPST is a technology that can preserve overall display quality when the backlight brightness is lowered, so that the user does not perceive a change in lightness of the displayed image. In this way, the DPST can reduce power consumption of the LCD, and does not affect visual experience of the user.

The DPST is a technology for reducing power consumed by a display screen by adjusting a gradation level. A gradation is an indicator representing lightness of an image, and a gradation level may affect lightness of a displayed or to-be-displayed image. Specifically, the electronic device may adjust the lightness of the displayed or to-be-displayed image based on a set gradation level by using a brightness compensation algorithm, to cause adjusted lightness of the image to match the backlight brightness, so as to ensure that the user does not perceive a change in the lightness of the displayed image. A higher gradation level indicates more brightness compensation required and longer computation time of the brightness compensation algorithm.

In other words, the DPST may modify pixel data of the displayed or to-be-displayed image by using the brightness compensation algorithm, to adjust the lightness of the displayed or to-be-displayed image.

Specifically, the DPST may include a plurality of gradation levels, and a higher gradation level indicates lower power consumption. For example, the DPST may include six gradation levels 1 to 6. The gradation level 6 corresponds to lowest power consumption, and the gradation level 1 corresponds to highest power consumption. Usually, the electronic device fixedly sets a gradation level to level 3. To save more power, the gradation level may be fixedly set to level 6. However, if the gradation level is fixedly set to level 6, because the computation time of the brightness compensation algorithm is longer, the user may perceive obvious brightness flicker, which may also be referred to as screen flickering, during interface switching. For example, the display screen flickers or blinks irregularly.

Embodiments of this application provide a gradation adjustment method, in which a change of a focus window may be detected, and a gradation level of a display screen may be dynamically adjusted based on the change of the focus window, to resolve a problem that a user may perceive obvious brightness flicker during interface switching.

The gradation adjustment method provided in embodiments of this application may be applied to an electronic device. The electronic device may be a terminal device having a display screen, for example, a mobile phone, a tablet computer, a notebook computer, or a computer. A specific form of the electronic device is not limited in embodiments of this application.

In the following embodiments, an example in which the electronic device is a notebook computer is used to describe the gradation adjustment method in embodiments of this application.

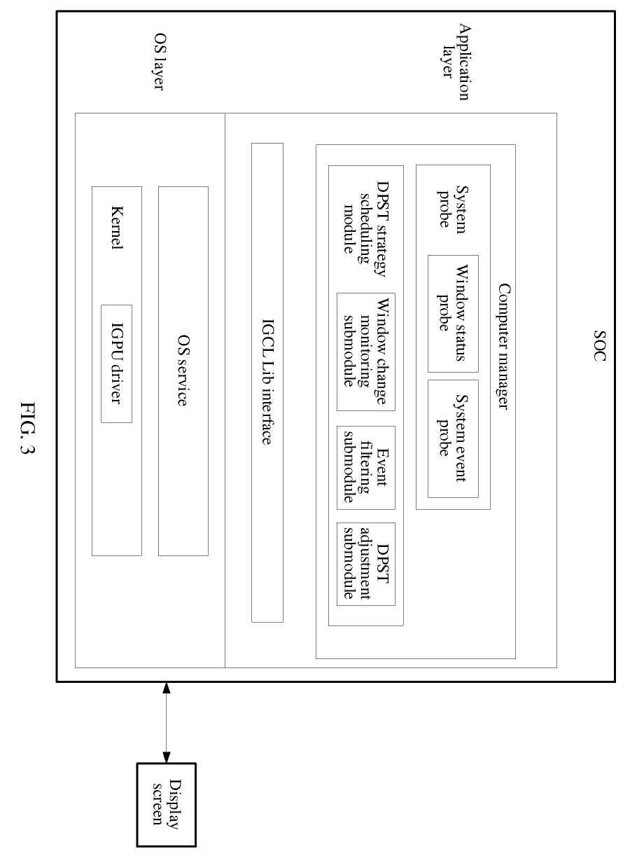

FIG. 2 is a diagram of a hardware structure of an electronic device 100 according to an embodiment of this application.

As shown in FIG. 2, the electronic device 100 may further include a processor 110, an external memory interface 120, an internal memory 121, a universal serial bus (USB) interface 130, a charging management module 140, a power supply management module 141, a battery 142, a wireless communication module 150, a display screen 160, and the like.

It may be understood that the structure shown in this embodiment constitutes no specific limitation on the electronic device 100. In some other embodiments, the electronic device 100 may include more or fewer components than those shown in the figure, some components may be combined, some components may be split, or different component arrangements may be used. The components shown in the figure may be implemented by hardware, software, or a combination of software and hardware.

The processor 110 may include one or more processing units. For example, the processor 110 may include an application processor (AP), a modem processor, a graphics processing unit (GPU), an image signal processor (ISP), a controller, a memory, a video codec, a digital signal processor (DSP), a baseband processor, a neural-network processing unit (NPU), and/or the like. Different processing units may be independent components, or may be integrated into one or more processors.

The controller may be a nerve center and a command center of the electronic device 100. The controller may generate an operation control signal based on instruction operation code and a timing signal, to implement control of instruction fetching and instruction execution.

A memory configured to store instructions and data may be further disposed in the processor 110. In some embodiments, the memory in the processor 110 is a cache. The memory may store instructions or data recently used or cyclically used by the processor 110. When needing to use the instructions or the data again, the processor 110 may directly invoke the instructions or the data from the memory. This avoids repeated access and reduces waiting time of the processor 110, thereby improving system efficiency.

In some embodiments, the processor 110 may include one or more interfaces. The interface may include an I2C interface, an inter-integrated circuit sound (I2S) interface, a pulse code modulation (PCM) interface, a universal asynchronous receiver/transmitter (UART) interface, a mobile industry processor interface (MIPI), a general-purpose input/output (GPIO) interface, a subscriber identity module (SIM) interface, a USB interface, and/or the like.

It may be understood that an interface connection relationship between the modules shown in this embodiment is merely an example for description, and constitutes no limitation on the structure of the electronic device 100. In some other embodiments, the electronic device 100 may alternatively use an interface connection manner different from that in the foregoing embodiment, or use a combination of a plurality of interface connection manners.

The charging management module 140 is configured to receive a charging input from a charger. The charger may be a wireless charger or a wired charger. The charging management module 140 may supply power to the electronic device by the power supply management module 141 while charging the battery 142.

The power supply management module 141 is configured to be connected to the battery 142, the charging management module 140, and the processor 110. The power supply management module 141 receives an input from the battery 142 and/or the charging management module 140, and supplies power to the processor 110, the internal memory 121, an external memory, the display screen 160, the wireless communication module 150, and the like. In some embodiments, the power supply management module 141 and the charging management module 140 may alternatively be disposed in a same device.

The wireless communication module 150 may provide a wireless communication solution applied to the electronic device 100, including, a WLAN (for example, Wi-Fi), Bluetooth, a global navigation satellite system (global navigation satellite system, GNSS), frequency modulation (FM), near field communication (NFC), an infrared (IR) technology, and the like. For example, in this embodiment of this application, the electronic device 100 may establish a Bluetooth connection to a terminal device (such as a wireless headset 100) through the wireless communication module 150.

The wireless communication module 150 may be one or more devices that integrate at least one communication processing module. The wireless communication module 150 receives an electromagnetic wave via an antenna, performs frequency modulation and filtering on an electromagnetic wave signal, and sends a processed signal to the processor 110. The wireless communication module 150 may further receive a to-be-sent signal from the processor 110, perform frequency modulation and amplification on the to-be-sent signal, and convert an amplified signal into an electromagnetic wave for radiation via the antenna.

The electronic device 100 implements a display function by using the GPU, the display screen 160, the application processor, and the like. The GPU is a microprocessor for image processing and is connected to the display screen 160 and the application processor. The GPU is configured to perform mathematical and geometric calculation for graphics rendering. The processor 110 may include one or more GPUs that execute program instructions to generate or change display information.

The display screen 160 is configured to display an image, a video, or the like. The display screen 194 includes a display panel. The display panel may be a liquid crystal display (LCD), an organic light-emitting diode (OLED), an active-matrix organic light emitting diode or an active-matrix organic light emitting diode (AMOLED), a flexible light-emitting diode (FLED), a Miniled, a MicroLed, a Micro-oLed, a quantum dot light emitting diode (QLED), or the like.

The external memory interface 120 may be configured to be connected to an external memory card, for example, a Micro SD card, to expand a storage capability of the electronic device 100. The external memory card communicates with the processor 110 through the external memory interface 120, to implement a data storage function, for example, storing files such as music and a video into the external memory card.

The internal memory 121 may be configured to store computer-executable program code. The executable program code includes instructions. The processor 110 runs the instructions stored in the internal memory 121, to perform various functional applications and data processing of the electronic device 100. For example, in this embodiment of this application, the processor 110 may execute the instructions stored in the internal memory 121. The internal memory 121 may include a program storage area and a data storage area.

The program storage area may store an operating system, an application needed by at least one function (for example, a sound playback function and an image display function), and the like. The data storage area may store data (for example, audio data and a phone book) and the like created during use of the electronic device 100. In addition, the internal memory 121 may include a high-speed random access memory, and may further include a non-volatile memory, for example, at least one magnetic disk storage device, a flash memory device, or a universal flash storage (UFS).

A software system of the electronic device 100 may use a layered architecture, an event-driven architecture, a microkernel architecture, a microservice architecture, or a cloud architecture. In this embodiment of the present invention, a software structure of the electronic device 100 is described by using a Windows system with a layered architecture as an example.

FIG. 3 is a diagram of a software architecture of an electronic device 100 according to an embodiment of this application.

As shown in FIG. 3, software is divided into several layers in a layered architecture, and each layer has a clear role and task. The layers communicate with each other through a software interface. In some embodiments, a Windows system includes an application layer and an operating system (OS) layer. The application layer and the OS layer may run on a system-on-a-chip (SOC). The SOC may be connected to an external device through a bus. The external device may include a display screen, a camera, a keyboard, a mouse, and the like.

The application layer may include a computer manager application (APP). The application layer may further include another application (not shown in the figure), for example, a music application, a video application, a game application, an office application, a social application, a shopping application, or a browser. This is not limited in this application.

The OS layer may include an OS service and a kernel. The kernel may include an IGPU driver. The IGPU driver is an integrated graphics card driver. The kernel may further include drivers, such as a mouse driver, an audio and video driver, a camera driver, and a keyboard driver. This is not limited in this application.

The computer manager APP may include a system probe and a DPST strategy scheduling module. The system probe may include a window status probe and a system event probe. The DPST strategy scheduling module may include a window status monitoring submodule, an event filtering submodule, and a DPST adjustment submodule.

The window status probe may monitor whether a focus window of the electronic device 100 changes. When detecting that the focus window changes, the window status probe may send a window status change notification to the window status monitoring submodule, to notify the DPST strategy scheduling module that the focus window changes.

In response to detecting that the focus window changes, the DPST adjustment submodule may execute a gradation adjustment strategy based on a change of the focus window. For example, a gradation is first adjusted to level 3, and then adjusted to level 6 stepwise.

The system event probe may monitor a sleep event and a power-on event of the electronic device 100. When detecting the sleep exit event or the power-on event of the electronic device 100, the system event probe may send a notification about the sleep exit event or the power-on event to the event filtering submodule, to notify the DPST strategy scheduling module that the system exits sleep mode or is powered on.

In response to detecting that the system exits sleep mode or is powered on, the DPST adjustment submodule may execute a sleep-exit or power-on based gradation adjustment strategy. For example, the gradation is directly adjusted to level 3.

After determining a gradation level to be adjusted to, the DPST strategy scheduling module may deliver a gradation level parameter through an interface (for example, a ctlGetPowerOptimizationSetting function) in an IGCL library (IGCL Lib). Next, the IGCL library delivers the gradation level parameter to an integrated graphics processing unit (IGPU) driver. Then, an IGPU, a CPU, a GPU, or the like of the SOC may perform brightness compensation processing on a displayed or to-be-displayed image based on the received gradation level parameter by using a brightness compensation algorithm. Finally, an image that has undergone the brightness compensation processing is sent to the display screen for display.

It should be noted that the Windows system is used as an example for description in this embodiment of this application. In another operating system (for example, an Android system or an IOS system), the solutions of this application can still be implemented provided that the functions implemented by functional modules are similar to those implemented in this embodiment of this application.

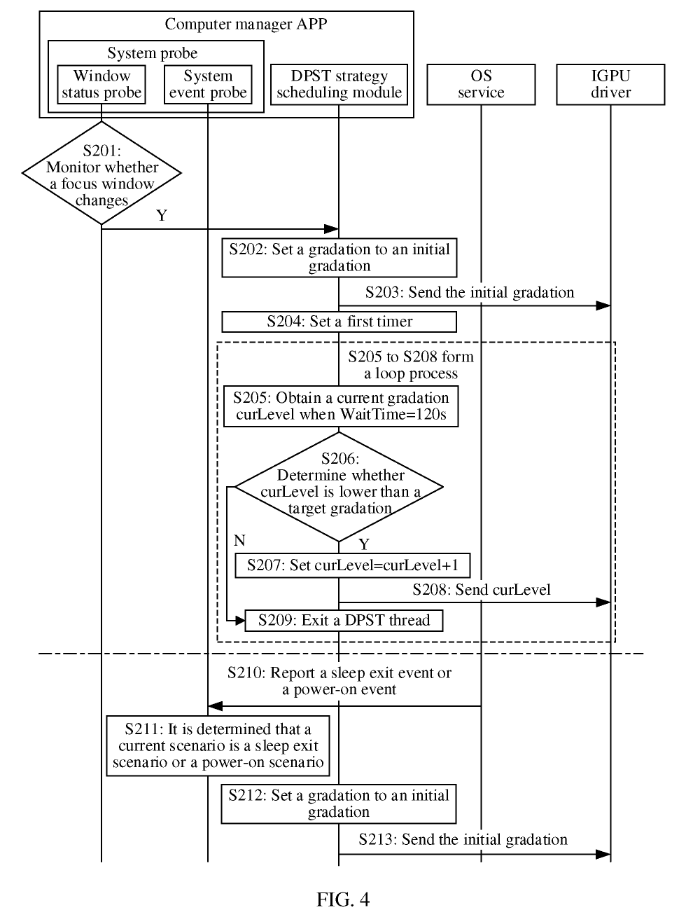

FIG. 4 is a diagram of module interaction of a gradation adjustment method according to an embodiment of this application. The following embodiment describes an example of the gradation adjustment method in this embodiment of this application by using an example in which a window status probe, a system event probe, and a DPST strategy scheduling module may respectively be independent modules, and a window status monitoring submodule, an event filtering submodule, and a DPST adjustment submodule may be three threads in the DPST strategy scheduling module. The window status monitoring submodule may also be referred to as a window status monitoring thread, the event filtering submodule may also be referred to as an event filtering thread, and the DPST adjustment submodule may also be referred to as a DPST adjustment thread. The window status monitoring thread, the event filtering thread, and the DPST adjustment thread may be asynchronous threads.

As shown in FIG. 4, the gradation adjustment method provided in this embodiment of this application may include the following steps.

S201: The window status probe monitors whether a focus window changes.

S202: The DPST strategy scheduling module sets a gradation of an electronic device to an initial gradation when it is detected that the focus window changes.

For example, the electronic device displays a first window of a first application at a first moment. For example, the first application is a video application, and the first window is a search interface of the video application. In response to an operation of a user on the first application, the electronic device displays a second window at a second moment. For example, the user exits the video application and returns to a home screen of the electronic device. When the search interface of the video application is switched to the home screen on the electronic device, the window status probe may detect that the focus window changes from the first window to the second window, to determine that the focus window changes.

After it is detected that the focus window changes, the DPST strategy scheduling module may first set the gradation of the electronic device to the initial gradation. The initial gradation may be a gradation at a low level. In this way, because for a gradation at a low level, computation time of the brightness compensation algorithm is short, it can be ensured that no screen flickering occurs after the second window is switched. For example, in this embodiment of this application, a gradation level of the initial gradation may be level 3.

In some embodiments, a power supply mode of the electronic device may be further monitored. The power supply mode may include alternating current (AC) power supply mode and a direct current (DC) power supply mode. When the power supply mode of the electronic device is AC, it indicates that the electronic device is connected to an adapter, and is powered by a power supply through a socket or the like. In such power supply mode, a problem of power consumption of a display screen can be neglected. When the power supply mode of the electronic device is DC, it indicates that the electronic device is powered by a battery. In such power supply mode, the problem of the power consumption of the display screen needs to be considered.

Therefore, in this embodiment of this application, when it is detected that the power supply mode of the electronic device is DC, and the focus window changes, the DPST strategy scheduling module sets the gradation of the electronic device to the initial gradation. In other words, if it is detected that the focus window changes, and the power supply mode is AC, the DPST strategy scheduling module may not be triggered to perform step S202.

S203: The DPST strategy scheduling module sends the initial gradation to an IGPU driver.

In some embodiments, the gradation level may be set by invoking a ctlGetPowerOptimizationSetting function. The ctlGetPowerOptimizationSetting function is an interface used for setting and obtaining a gradation level in the intel IGCL library. After the initial gradation is delivered to the IGPU driver, an IGPU, a CPU, a GPU and the like of an SOC may perform brightness compensation processing on a displayed or to-be-displayed image based on the received initial gradation using a brightness compensation algorithm. Finally, an image that has undergone the brightness compensation processing is sent to the display screen for display.

S204: The DPST strategy scheduling module sets a first timer, where the first timer is configured to count stability duration of the focus window.

The stability duration of the focus window is duration in which the focus window remains unchanged. For example, after the focus window changes to the second window, duration in which the second window remains as the focus window without another focus window change occurring.

In this embodiment of this application, after it is detected that the focus window changes, the gradation is first set to the initial gradation. Then, if the focus window does not change again within preset stability duration, the DPST adjustment thread may be started to adjust the gradation level from the initial gradation to a target gradation stepwise. A gradation level of the target gradation is higher than the gradation level of the initial gradation. In this way, a gradation is gradually adjusted from a gradation at a lower level to a target gradation at a higher level, to resolve a problem of screen flickering that occurs in a case that the gradation is fixedly set to level 6.

A specific value of the preset stability duration is not limited in this embodiment of this application. For example, the preset stability duration may be 120s. If elapsed time (WaitTime) of the first timer reaches 120s, the DPST adjustment thread may be started.

Step S201 to step S204 may be understood as logic for determining that the focus window is stable. After the focus window is stable, the DPST adjustment thread may be started, to adjust the gradation level from the initial gradation to the target gradation stepwise. For a step of adjusting the gradation level from the initial gradation to the target gradation stepwise, refer to steps S205 to S208.

S205: When the elapsed time WaitTime of the first timer reaches the preset stability duration, the DPST strategy scheduling module obtains a current gradation curLevel.

In some embodiments, the current gradation curLevel may be obtained by invoking the ctlGetPowerOptimizationSetting function.

S206: Determine whether the current gradation curLevel is lower than the target gradation.

The target gradation is not limited in this embodiment of this application. For example, the target gradation may be a gradation at a highest level in a DPST, for example, the target gradation is level 6. It should be understood that if a gradation at a highest level in a future DPST exceeds level 6, the target gradation may be the gradation at a highest level in the future DPST.

S207: Set the gradation curLevel to curLevel+1 if the current gradation curLevel is lower than the target gradation.

S208: The DPST strategy scheduling module sends the current gradation curLevel to the IGPU driver.

The current gradation curLevel sent by the DPST strategy scheduling module to the IGPU driver is a most recently set gradation curLevel.

S209: Cyclically perform step S205 to step S208 based on a preset cycle time interval, and when the current gradation is equal to the target gradation, exit the DPST adjustment thread.

For example, a second timer may be set, and the second timer is configured to count a preset cycle time interval. In this way, after curLevel=curLevel+1 is set in S207, the second timer may start timing. When the elapsed time reaches the preset cycle time interval, S205 to S208 are performed again until the current gradation curLevel is not lower than the target gradation.

Steps S205 to S208 form a loop process. The foregoing loop process is described using an example in which the gradation level of the initial gradation is level 3, the gradation level of the target gradation is level 6, and the preset cycle time interval is 12s.

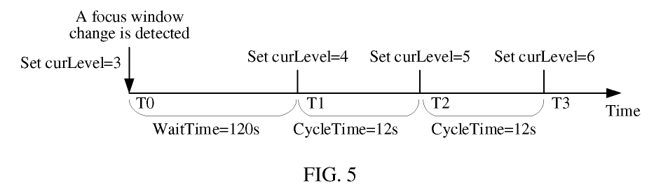

With reference to FIG. 4 and FIG. 5, at a moment T0, it is detected that the focus window changes, and the current gradation curLevel is set to level 3. When the stability duration WaitTime of the focus window counted by the first timer reaches 120s, steps S205 to S208 are performed. Specifically, the current gradation curLevel obtained for the first time when WaitTime reaches 120s is level 3. Because the current gradation curLevel is level 3 and is lower than the target gradation (that is, level 6), at a moment T1 when WaitTime reaches 120s, the gradation curLevel is set to level 4. After the gradation curLevel is set to level 4, the current gradation curLevel obtained for the second time when the cycle time interval CycleTime reaches 12s is level 4. Because the current gradation curLevel is level 4 and is lower than the target gradation (that is, level 6), at a moment T2 when the first CycleTime reaches 12s, the gradation curLevel is set to level 5. After the gradation curLevel is set to level 5, the current gradation curLevel obtained for the third time when the cycle time interval CycleTime reaches 12s again is level 5. Because the current gradation curLevel is level 5 and is lower than the target gradation (that is, level 6), at a moment T3 when the second CycleTime reaches 12s, the gradation curLevel is set to (that is, level 6). After the gradation curLevel is set to level 6, the current gradation curLevel obtained for the third time when a cycle time interval CycleTime reaches 12s again is level 6. Because the current gradation curLevel is level 6 and is not lower than the target gradation (that is, level 6), at this time, a cycle algorithm ends, and the DPST adjustment thread may be exited.

In this way, in the gradation adjustment method provided in this embodiment of this application, after it is detected that the focus window changes, the gradation is first adjusted to a gradation at a low level, for example, the gradation at a low level is level 3, to prevent screen flickering on an interface switched to. Further, when the focus window is stable, the gradation is gradually increased to a higher level. For example, the gradation at a higher level is level 6. In this way, after the focus window is changed, in other words, after an interface is switched, no screen flickering occurs, and power consumed by the display screen can be minimized.

It should be noted that, in the foregoing embodiment, only a scenario in which a focus window change is detected is used as an example to describe an example of the gradation adjustment method provided in this embodiment of this application. In some embodiments, after the electronic device exits sleep mode or is powered on, display of an interface is also involved, and therefore a problem of screen flickering is also involved.

To resolve the problem of screen flickering of the electronic device in a scenario in which the electronic device exits sleep mode or is powered on, as shown in FIG. 4, the gradation adjustment method provided in this embodiment of this application may further include the following steps.

S210: An OS service reports a sleep exit event or a power-on event to the system event probe.

S211: The system event probe determines that a current scenario is a sleep exit event or a power-on event based on the sleep exit event or the power-on event reported by the OS service.

S212: The DPST strategy scheduling module sets a gradation to an initial gradation.

After the sleep exit event, a display interface of the electronic device usually displays an interface before sleep. After power-on, the display interface of the electronic device usually displays a home screen of the electronic device. In this embodiment of this application, after the electronic device exits sleep mode or is powered on, the gradation is directly set to the initial gradation. For example, a gradation level of the initial gradation is level 3. In this way, no screen flickering occurs when the interface before sleep or the home screen of the electronic device is displayed.

After the interface before sleep is displayed or the home screen of the electronic device is displayed, the foregoing steps S201 to S209 may be performed. To be specific, after sleep-exit or power-on, the gradation level is first set to level 3. Then, if it is detected that the focus window changes, the gradation level is first set to level 3, and then the gradation level is gradually adjusted to level 6. In this way, no screen flickering occurs during interface switching in a scenario in which the electronic device exits sleep mode or is powered on, or the focus window changes.

In some embodiments, a computer manager APP is started after the electronic device is powered on. A configuration file may be loaded when the computer manager APP is started. For example, the configuration file may include a machine name, the initial gradation, stability duration WaitTime of the focus window, a preset cycle time interval CycleTime, and the like that match the gradation adjustment solution provided in this embodiment of this application.

S213: The DPST strategy scheduling module sends the initial gradation to an IGPU driver.

It should be noted that the gradation adjustment solution provided in the foregoing embodiment is applicable to a case in which there is no new focus window change during an entire gradation adjustment process. However, during actual running, a new focus window change may occur at different stages of gradation adjustment. If a new focus window change occurs, it means that a previous focus window is no longer displayed. Therefore, there is no need to continue to adjust the gradation of the previous focus window. In other words, if a new focus window change occurs, gradation adjustment that is being performed needs to be interrupted, and then step S202 and subsequent steps are performed again. Therefore, this embodiment of this application may further include the following interruption mechanisms, to adapt to a case in which a new focus window change occurs during the gradation adjustment.

The following describes the interruption mechanisms provided in this embodiment of this application.

A first interruption mechanism is applicable to a case in which a window status probe further monitors whether a new focus window change occurs when stability duration of the focus window that is counted by a first timer does not reach preset stability duration.

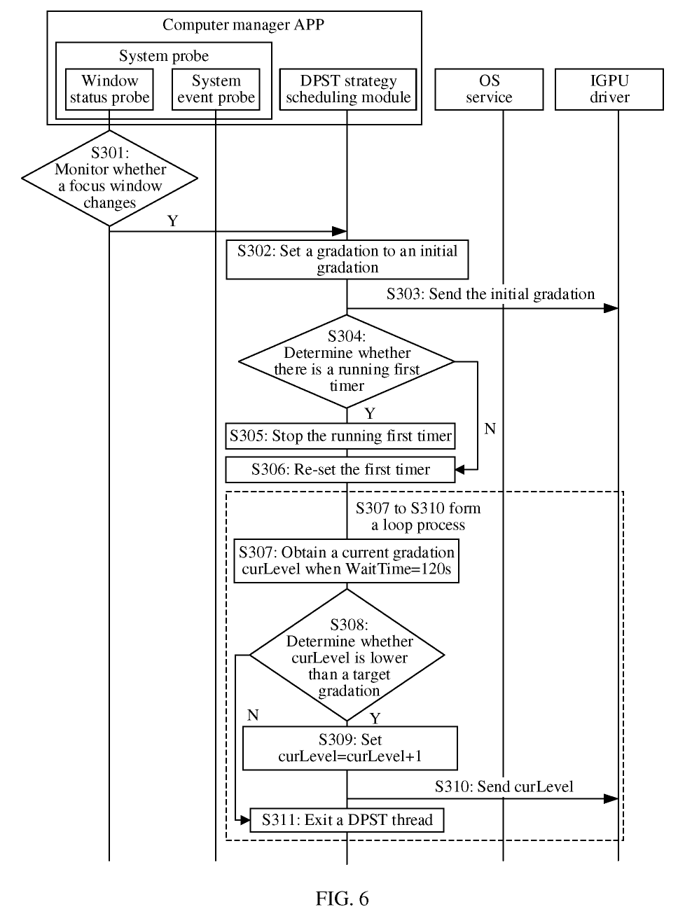

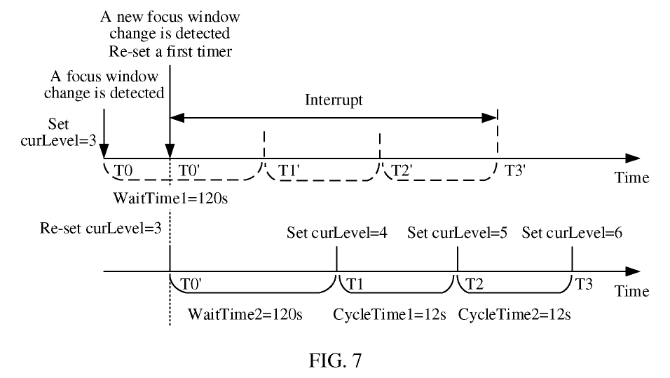

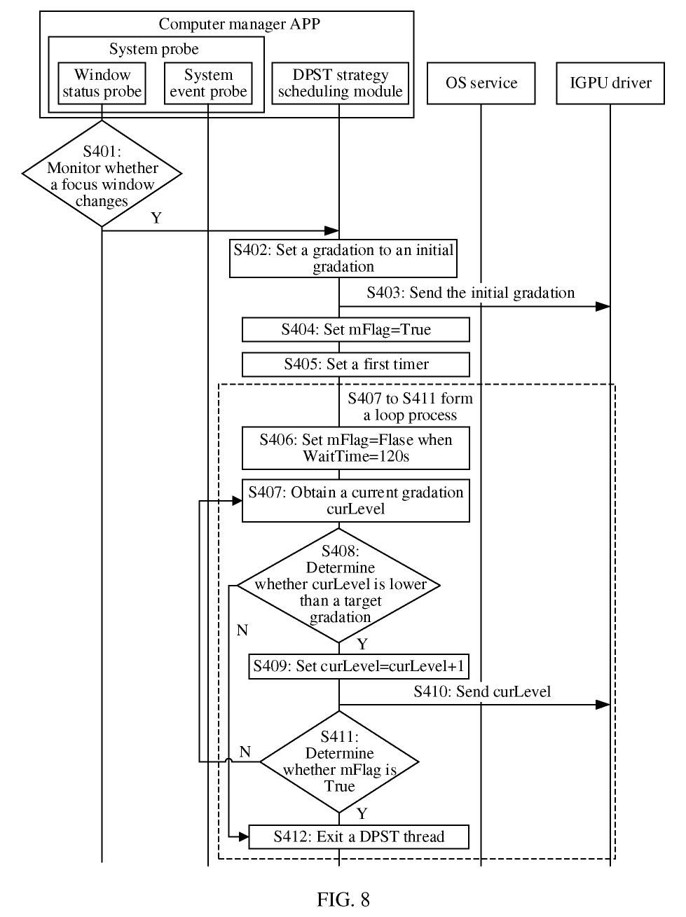

For example, as shown in FIG. 6 and FIG. 7, a gradation adjustment solution including the first interruption mechanism may include the following steps.

S301: The window status probe monitors whether a focus window changes.

S302: The DPST strategy scheduling module sets a gradation of an electronic device to an initial gradation when it is detected that the focus window changes.

S303: The DPST strategy scheduling module sends the initial gradation to an IGPU driver.

S304: The DPST strategy scheduling module determines whether there is a running first timer.

S305: If it is determined that there is a running first timer, stop the running first timer.

S306: If it is determined that there is no running first timer or after the running first timer is stopped, the DPST strategy scheduling module re-sets the first timer, where the first timer is configured to count the stability duration of the focus window.

S307: When the elapsed time WaitTime of the first timer reaches the preset stability duration, the DPST strategy scheduling module obtains a current gradation curLevel.

S308: Determine whether the current gradation curLevel is lower than the target gradation.

S309: Set the gradation curLevel to curLevel+1 if the current gradation curLevel is lower than the target gradation.

S310: The DPST strategy scheduling module sends the current gradation to the IGPU driver.

S311: Cyclically perform step S307 to step S310 based on a preset cycle time interval until the current gradation is equal to the target gradation.

With reference to FIG. 6 and FIG. 7, at a moment T0, it is detected that the focus window changes, the current gradation curLevel is set to level 3, and stability duration WaitTime1 of the focus window that is counted by the first timer is set. If a new focus window change is detected at a moment T0' within the stability duration WaitTime1 of the focus window, gradation adjustment that is being performed is interrupted (in other words, a process from T0' to T3' in FIG. 7 is interrupted). Instead, the current gradation curLevel is re-set to level 3, and the running first timer is stopped. Then, the DPST strategy scheduling module may re-set the first timer, to re-count stability duration WaitTime2 of the focus window from 0s. If no new focus window change is detected within the re-counted WaitTime2, the following step S307 to step S310 may be performed. In other words, at a moment T1 when WaitTime2 reaches 120s, the gradation curLevel is set to level 4. After the gradation curLevel is set to level 4, the current gradation curLevel obtained for the second time when the cycle time interval CycleTime reaches 12s is level 4. Because the current gradation curLevel is level 4 and is lower than the target gradation (that is, level 6), the gradation curLevel is set to level 5 at a moment T2 when the first CycleTime reaches 12s. After the gradation curLevel is set to level 5, the current gradation curLevel obtained for the third time when the cycle time interval CycleTime reaches 12s again is level 5. Because the current gradation curLevel is level 5 and is lower than the target gradation (that is, level 6), the gradation curLevel is set to level 6 at a moment T3 when the second CycleTime reaches 12s. After the gradation curLevel is set to level 6, the current gradation curLevel obtained for the third time when a cycle time interval CycleTime reaches 12s again is level 6. Because the current gradation curLevel is level 6 and is not lower than the target gradation (that is, level 6), at this time, a cycle algorithm ends, and the DPST adjustment thread may be exited.

If a new focus window change is detected again within re-counted WaitTime2, the steps of re-setting the gradation to level 3, stopping the running first timer, and re-setting the first timer are performed again. In this way, the gradation adjustment solution shown in FIG. 6 may be applied to a case in which the window status probe further monitors whether a new focus window change occurs when the stability duration of the focus window that is counted by the first timer does not reach the preset stability duration. According to the gradation adjustment solution shown in FIG. 6, a gradation adjustment strategy based on a previous focus window change can be interrupted promptly.

It should be noted that, for steps S301 to S303 in the foregoing embodiment, refer to the descriptions of steps S201 to S203, and for steps S307 to S311, refer to the descriptions of steps S205 to S209. Details are not described herein again.

A second interruption mechanism is applicable to a case in which the window status probe further monitors whether anew focus window change occurs during performing of S205 to S207, or S307 to S309.

For example, as shown in FIG. 8, a gradation adjustment solution including the second interruption mechanism may include the following steps.

S401: The window status probe monitors whether a focus window changes.

S402: The DPST strategy scheduling module sets a gradation of an electronic device to an initial gradation when it is detected that the focus window changes.

S403: The DPST strategy scheduling module sends the initial gradation to an IGPU driver.

S404: The DPST strategy scheduling module sets a DPST characteristic parameter mFlag to True.

In this embodiment of this application, when the focus window changes, a window status monitoring thread may set mFlag to True, where mFlag=True may indicate that the focus window changes.

mFlag may include two parameter values, which are mFlag=True and mFlag=Flase. The DPST characteristic parameter mFlag may be a global variable. In other words, each thread in the DPST strategy scheduling module may know that mFlag=True or mFlag=Flase currently.

For example, after the window status monitoring thread sets mFlag=True, a DPST adjustment thread may know that mFlag=True. Correspondingly, after the DPST adjustment thread sets mFlag=Flase, the window status monitoring thread may know that mFlag=Flase.

S405: The DPST strategy scheduling module sets a first timer, where the first timer is configured to count stability duration of the focus window.

S406: When the stability duration of the focus window reaches preset stability duration, the DPST strategy scheduling module sets the DPST characteristic parameter mFlag to Flase.

In this embodiment of this application, when the stability duration of the focus window reaches the preset stability duration, the DPST adjustment thread may first set the DPST characteristic parameter mFlag to Flase, to start the DPST adjustment thread to adjust the initial gradation to a target gradation. In other words, mFlag=Flase may be understood as a switch for starting the DPST adjustment thread.

S407: The DPST strategy scheduling module obtains a current gradation curLevel.

S408: The DPST strategy scheduling module determines whether the current gradation curLevel is lower than the target gradation.

S409: If the current gradation curLevel is lower than the target gradation, the DPST strategy scheduling module sets a gradation level curLevel to curLevel+1.

S410: The DPST strategy scheduling module sends the current gradation to the IGPU driver.

S411: The DPST strategy scheduling module determines whether the DPST characteristic parameter mFlag is True.

In this embodiment of this application, mFlag is set to True once a focus window change is detected. In this way, if a new focus window change is detected during performing of steps S406 to S409, mFlag=Flase originally set by the DPST adjustment thread is re-set to mFlag=True.

In other words, in this embodiment of this application, whether a new focus window change is detected during performing of steps S406 to S409 may be determined based on mFlag=True or mFlag=Flash. Specifically, if the DPST strategy scheduling module determines that the DPST characteristic parameter mFlag=True in step S411, it indicates that a new focus window change is detected in a process of steps S406 to S409. Otherwise, if the DPST strategy scheduling module determines that the DPST characteristic parameter mFlag=Flase in step S411, it indicates that no new focus window change is detected in the process of steps S406 to S409.

S412: Exit the DPST adjustment thread if it is determined that the DPST characteristic parameter mFlag is True.

When it is determined that the DPST characteristic parameter mFlag is not True, step S407 to step S411 are cyclically performed based on a preset cycle time interval until the current gradation is equal to the target gradation.

It should be noted that, in this embodiment of this application, step S411 needs to be performed each time before counting a cycle time interval. If it is determined that the DPST characteristic parameter mFlag is not True, the counting of a cycle time interval is started again.

It should be noted that, in some embodiments, step S411 may be performed before step S410. In this way, if the DPST strategy scheduling module determines that the DPST characteristic parameter mFlag is True, step S410 is not performed.

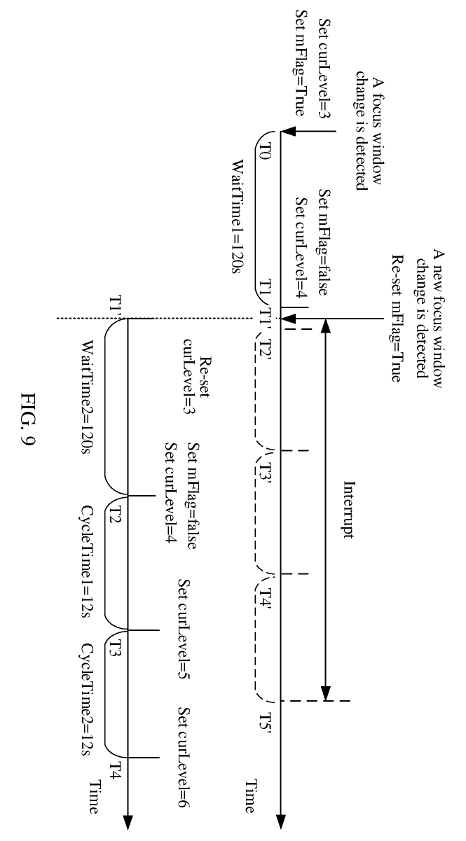

For example, as shown in FIG. 9, it is detected that the focus window changes at a moment T0, the current gradation curLevel is set to level 3, and mFlag=True is set. Next, the first timer is set to count stability duration WaitTime1 of the focus window. At a moment T1 when WaitTime1 reaches 120s, mFlag=Flase is set. Then, the gradation level curLevel is set to level 4. If a new focus window change is detected again at a moment T1' during adjustment of the gradation from level 3 to level 4, the current gradation curLevel is re-set to level 3, and mFlag=True is re-set. In this way, after the gradation is adjusted to level 4, when it is determined that mFlag=True, a gradation adjustment process based on a previous focus window change is interrupted (in other words, a process from T2' to T5' in FIG. 9 is interrupted), and a gradation adjustment process based on a latest focus window change (in other words, a process from T1' to T4 in FIG. 9) is started again.

In this way, the gradation adjustment solution shown in FIG. 8 may be applied to a case in which the window status probe further monitors whether a new focus window change occurs during performing of S407 to S409. According to the gradation adjustment solution shown in FIG. 8, a gradation adjustment strategy based on a previous focus window change can be interrupted promptly.

A third interruption mechanism is applicable to a case in which the window status probe further monitors whether a new focus window change occurs within a time period of the preset cycle time interval.

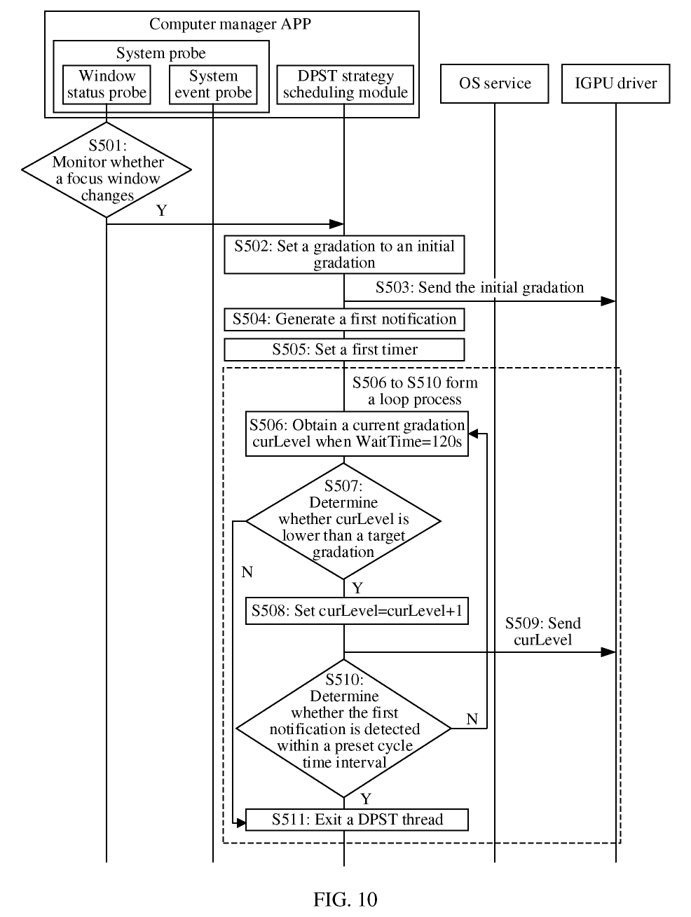

For example, as shown in FIG. 10, a gradation adjustment solution including the third interruption mechanism may include the following steps.

S501: The window status probe monitors whether a focus window changes.

S502: The DPST strategy scheduling module sets a gradation of an electronic device to an initial gradation when it is detected that the focus window changes.

S503: The DPST strategy scheduling module sends the initial gradation to an IGPU driver.

S504: The DPST strategy scheduling module generates a window change notification, where the window change notification is used for notifying that a focus window change is detected.

S505: The DPST strategy scheduling module sets a first timer, where the first timer is configured to count stability duration of the focus window.

S506: The DPST strategy scheduling module obtains a current gradation when the stability duration of the focus window reaches preset stability duration.

S507: The DPST strategy scheduling module determines whether the current gradation curLevel is lower than the target gradation.

S508: If the current gradation curLevel is lower than the target gradation, the DPST strategy scheduling module sets a gradation curLevel to curLevel+1.

S509: The DPST strategy scheduling module sends the current gradation to the IGPU driver.

S510: The DPST strategy scheduling module determines whether the window change notification is detected within the preset cycle time interval.

It should be noted that steps S502, S504, and S505 may be performed by the window status monitoring thread, and S506 to S510 may be performed by the DPST adjustment thread. Because the window status monitoring thread and the DPST adjustment thread are executed as asynchronous threads, if the focus window changes within a time period of the cycle time interval, for example, the DPST adjustment thread is not notified, the DPST adjustment thread does not learn that the focus window changes.

To enable the DPST adjustment thread to learn in time that a new focus window change occurs, gradation adjustment that is being performed is interrupted. In this embodiment of this application, when a new focus window change is detected, the window status monitoring thread generates a window change notification, and the window change notification may be specifically for the DPST adjustment thread to detect within the preset cycle time interval. In other words, if the new focus window change occurs within a time period of the preset cycle time interval, a window change notification can be detected by the DPST adjustment thread. If the new focus window change is not happened within the time period of the preset cycle time interval, no window change notification is to be detected by the DPST adjustment thread.

In this way, the DPST adjustment thread may determine, within the time period of the preset cycle time interval, whether the window change notification is detected. If the window change notification is detected, it indicates that the focus window changes again. If no window change notification is detected, it indicates that no new focus window change occurs within the time period of the preset cycle time interval, and next gradation adjustment may be continued.

S511: Exit the DPST adjustment thread if the window change notification is detected within the preset cycle time interval.

If it is determined that no window change notification is detected within the preset cycle time interval, step S506 to step S510 are performed again until the current gradation is equal to the target gradation.

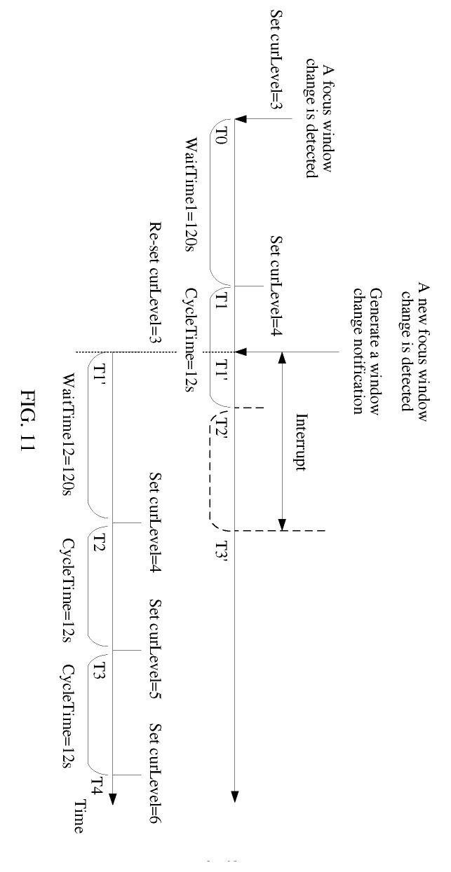

For example, as shown in FIG. 11, it is detected that the focus window changes at a moment T0, the current gradation curLevel is set to level 3. Next, the first timer is set to count stability duration WaitTime1 of the focus window. At a moment T1 when WaitTime1 reaches 120s, the current gradation curLevel is adjusted from level 3 to level 4. Then, when the preset cycle time interval reaches 12s, a process of adjusting the current gradation curLevel from level 4 to level 5 starts to be performed. If a new focus window change is detected again at a moment T1' of the preset cycle time interval CycleTime, a window change notification is generated. In this way, because the DPST adjustment thread detects a window change notification within the time period of the preset cycle time interval, a gradation adjustment process (that is, a process from T1' to T3' in FIG. 11) based on a previous focus window change is interrupted, and a gradation adjustment process (that is, a process from T1' to T4 in FIG. 11) based on a latest focus window change is started again.

It should be noted that the three interruption mechanisms provided in the foregoing embodiments may be independently applied to the gradation adjustment solutions provided in embodiments of this application, or any two or three may be combined to be applied to the gradation adjustment solutions provided in embodiments of this application.

The following describes an example in which the three interruption mechanisms are combined and applied to a gradation adjustment solution provided in this embodiment of this application.

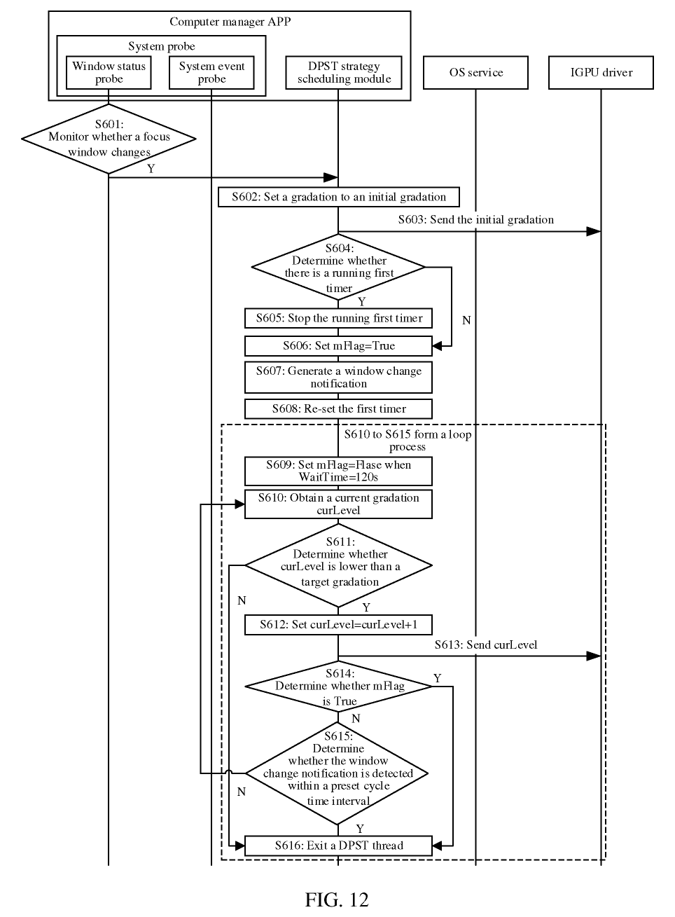

As shown in FIG. 12, that the three interruption mechanisms are combined and applied to the gradation adjustment solution provided in this embodiment of this application may include the following steps.

S601: The window status probe monitors whether a focus window changes.

S602: The DPST strategy scheduling module sets a gradation of an electronic device to an initial gradation when it is detected that the focus window changes.

S603: The DPST strategy scheduling module sends the initial gradation to an IGPU driver.

S604: The DPST strategy scheduling module determines whether there is a running first timer.

S605: If it is determined that there is a running first timer, stop the running first timer.

S606: If it is determined that there is no running first timer or after the running first timer is stopped, the DPST strategy scheduling module sets a DPST characteristic parameter mFlag to True.

S607: The DPST strategy scheduling module generates a window change notification, where the window change notification is used for notifying that a focus window change is detected.

S608: The DPST strategy scheduling module sets a first timer, where the first timer is configured to count stability duration of the focus window.

S609: When the stability duration of the focus window reaches preset stability duration, the DPST strategy scheduling module sets the DPST characteristic parameter mFlag to Flase.

S610: The DPST strategy scheduling module obtains a current gradation curLevel.

S611: The DPST strategy scheduling module determines whether the current gradation curLevel is lower than the target gradation.

S612: If the current gradation curLevel is lower than the target gradation, the DPST strategy scheduling module sets a gradation curLevel to curLevel+1.

S613: The DPST strategy scheduling module sends the current gradation to the IGPU driver.

S614: The DPST strategy scheduling module determines whether the DPST characteristic parameter mFlag is True.

S615: When it is determined that the DPST characteristic parameter mFlag is not True, the DPST strategy scheduling module determines whether the window change notification is detected within the preset cycle time interval.

S616: Exit the DPST adjustment thread if the window change notification is detected within the preset cycle time interval, or if it is determined that the DPST characteristic parameter mFlag is True.

If it is determined that no window change notification is detected within the preset cycle time interval, step S610 to step S615 are performed again until the current gradation is equal to the target gradation.

In this way, if a new focus window change occurs at a stage of waiting for stability of a focus window, steps S604, S605, and S608 may be performed to stop the running first timer and create a new first timer to re-start counting. In this way, the first interruption mechanism is applied, to interrupt a gradation adjustment process based on a previous focus window change. If a new focus window change occurs at a stage from S609 to S612, it may be determined, through steps S606, S609, and S614 based on a change of mFlag, that the new focus window change occurs at the stage from S609 to S612. In this way, the second interruption mechanism is applied, to interrupt a gradation adjustment process based on a previous focus window change. If a new focus window change occurs at a stage of the preset cycle time interval, it may be determined, through steps S607 and S615 based on the window change notification, that the new focus window change occurs at the stage of the preset cycle time interval. In this way, the third interruption mechanism is applied, to interrupt a gradation adjustment process based on a previous focus window change.

For steps S601 to S605, refer to the descriptions of steps S301 to S306. For steps S606, S608, and S614, refer to the descriptions of steps S404 to S412. For steps S607 and S615, refer to the descriptions of steps S504 to S511. Details are not described herein again.

It should be noted that, in the foregoing embodiment, only an adjustment strategy of increasing a gradation by one level each time as an example, and does not limit the gradation adjustment strategy. For example, gradation adjustment may alternatively be performed in a manner of increasing a gradation by two levels each time. For another example, the gradation adjustment may be performed in an adjustment manner of increasing a gradation by one level for a first time and increasing a gradation by two levels for a second time.

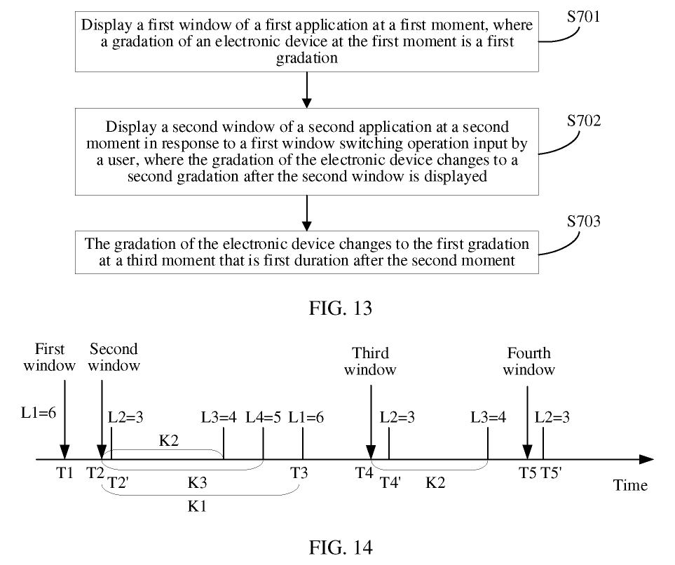

FIG. 13 is a flowchart of a gradation adjustment method according to an embodiment of this application. As shown in FIG. 13, the method may include the following steps.

S701: Display a first window of a first application at a first moment, where a gradation of an electronic device at the first moment is a first gradation (or may be referred to as a target gradation).

S702: Display a second window of a second application at a second moment in response to a first window switching operation input by a user, where the gradation of the electronic device changes to a second gradation (or may also be referred to as an initial gradation) after the second window is displayed, and the second gradation is lower than the first gradation.

S703: The gradation of the electronic device changes to the first gradation at a third moment that is first duration after the second moment.

For example, as shown in FIG. 14, a first window displayed at a first moment T1 may be a focus window. At a second moment T2, the focus window is switched from the first window to a second window. A first application and a second application may be a same application or different applications. This is not limited in this embodiment of this application.

After the second moment T2, a gradation changes to a second gradation L2 based on a change of the focus window. For example, at a moment T2' after the second moment T2, the gradation changes to the second gradation L2. A gradation level of a first gradation L1 may be level 6, and a gradation level of the second gradation L2 may be level 3.

For a specific implementation of detecting the change of the focus window, refer to the descriptions of steps S201 and S202. Details are not described herein again.

In some embodiments, as shown in FIG. 14, a process in which the gradation of the electronic device changes to the first gradation L1 at a third moment T3 that is separated from the second moment T2 by first duration K1 may include: The gradation of the electronic device changes to a third gradation L3 within second duration K2 after the second moment T2. The third gradation L3 is lower than the first gradation L1 and higher than the second gradation L2, and the second duration K2 is shorter than the first duration K1. The gradation of the electronic device changes to a fourth gradation L4 within third duration K3 after the second moment T2. The fourth gradation L4 is lower than the first gradation L1 and higher than the third gradation L3, and the third duration K3 is longer than the second duration K2 and shorter than the first duration K1.

In some embodiments, that the gradation of the electronic device changes to the third gradation L3 after the second duration K2 after the second moment T2 may be implemented in some manners: A first timer is set after the second moment T2, where the first timer is configured to count stability duration of the focus window. A first current gradation of the electronic device is obtained when elapsed time of the first timer reaches a preset stability duration, where the first current gradation is the second gradation L2. If the first current gradation L2 is lower than the first gradation L1, the gradation of the electronic device is adjusted from the second gradation L2 to the third gradation L3.

For example, a gradation level of the first gradation L1 is level 6, a gradation level of the second gradation L2 is level 3, a gradation level of the third gradation L3 is level 4, and a gradation level of the fourth gradation L4 is level 5. With reference to FIG. 4 and FIG. 14, the foregoing describes a process of adjusting the electronic device from the second gradation L2 to the first gradation L1 stepwise. Steps S201 to S208 may be performed once within a time period of the second duration K2, to adjust the gradation from the second gradation L2 to the third gradation L3. A time period of the third duration K3 includes the time period of the second duration K2. In addition, the loop process from S205 to S208 may be performed one more time within the time period of the third duration K3, to adjust the gradation from the third gradation L3 to the fourth gradation L4.

It should be noted that, for a specific implementation process in which the gradation of the electronic device changes to the first gradation L1 at the third moment T3 that is separated from the second moment T2 by the first duration K1, refer to the descriptions of steps S201 to S208. Details are not described herein again.

It should be further noted that, in the foregoing embodiment, two cyclic adjustment processes during adjustment of the second gradation L2 to the first gradation L1 stepwise is described merely as an example, and is not intended to limit a gradation adjustment manner. Specifically, refer to the descriptions of steps S201 to S208. For example, the adjustment process may be repeated a plurality of times until the gradation is adjusted to the first gradation.

In some embodiments, before the first timer is set, the method may further include: if there is a running first timer after the second moment T2, stopping a running first timer.

For example, refer to FIG. 6 and FIG. 7. Steps S301 to S310 may be performed once within the time period of the second duration K2. In this way, if a new focus window change is detected within elapsed time of the first timer, the running first timer may be stopped, and then the first timer is re-set to restart timing.

For a specific implementation process, refer to the descriptions in steps S301 to S310. Details are not described herein again.

In some embodiments, that the gradation of the electronic device changes to the fourth gradation within third duration after the second moment T2 may be implemented in the following manner: setting a DPST characteristic parameter to a first parameter after the second moment T2. Then, a first timer is set, where the first timer is configured to count stability duration of the focus window. When elapsed time of the first timer reaches preset stability duration, the DPST characteristic parameter is set to a second parameter. Then, the first current gradation of the electronic device is obtained, where the first current gradation is the second gradation L2. If the first current gradation is lower than the first gradation L1, the gradation of the electronic device is adjusted from the second gradation L2 to the third gradation L3. After the gradation of the electronic device is adjusted from the second gradation L2 to the third gradation L3, if the DPST characteristic parameter is the second parameter, a second current gradation of the electronic device is obtained, and the second current gradation is the third gradation L3. If the second current gradation is lower than the first gradation L1, the gradation of the electronic device is adjusted from the third gradation L3 to the fourth gradation L4.

For example, refer to FIG. 8 and FIG. 9. Steps S401 to step S411 may be performed once within the time period of the second duration K2. In this way, if no new focus window change is detected within a time period of S406 to S409 (or S406 to S410), it may be determined in step S411 that the DPST characteristic parameter is still a second parameter. In this way, a process in which the gradation of the electronic device is adjusted from the third gradation L3 to the fourth gradation L4 may be entered. If a new focus window change is detected within the time period of S406 to S409 (or S406 to S410), it may be determined in step S411 that the DPST characteristic parameter changes to the first parameter. In this way, the process of adjusting the gradation of the electronic device from the third gradation L3 to the fourth gradation L4 is not entered, and the process of continuing to adjust the third gradation L3 ends.

For a specific implementation process, refer to the descriptions in steps S401 to S412. Details are not described herein again.

It should be noted that the DPST characteristic parameter may be mFlag, the first parameter may be mFlag=True, and the second parameter may be mFlag=Flase. For another example, the first parameter may alternatively be mFlag=1, and the second parameter may be mFlag=0. This is not limited in this application.

In some embodiments, after the gradation of the electronic device is adjusted from the second gradation L2 to the third gradation L3, the method may further include: setting a second timer if the DPST characteristic parameter is the second parameter, where the second timer is configured to count a preset cycle time interval; and obtaining the second current gradation if elapsed time of the second timer reaches the preset cycle time interval and no focus window change notification is detected within the preset cycle time interval, where the focus window change notification is used for provide notification about a change of the focus window.

For example, refer to FIG. 12. After the gradation of the electronic device is adjusted from the second gradation L2 to the third gradation L3, step S614 may be performed. If it is determined in step S614 that the DPST characteristic parameter is the second parameter, step S615 may be further performed. If no window change notification is received within a time period of performing step S615, the process of adjusting the gradation of the electronic device from the third gradation L3 to the fourth gradation L4 may be entered. If a new focus window change occurs within the time period of performing step S615, a window change notification is received within the time period of performing step S615. In this way, based on the window change notification, the process of adjusting the gradation of the electronic device from the third gradation L3 to the fourth gradation L4 is not entered, and the process of continuing to adjust the third gradation L3 ends.

For a specific implementation process, refer to the descriptions in steps S601 to S616. Details are not described herein again.

In some embodiments, refer to FIG. 13. A third window is displayed at a fourth moment T4 in response to a second window switching operation input by a user. After the third window is displayed, a gradation of an electronic device changes to a second gradation L2 (for example, at a moment T4' after the fourth moment T4, the gradation changes to the second gradation L2), and the fourth moment T4 is after a third moment T3. The gradation of the electronic device changes to the third gradation L3 within second duration K2 after the fourth moment T4. The third gradation L3 is lower than a first gradation L1 and higher than the second gradation L2. After the gradation of the electronic device changes to the third gradation L3, in response to a third window switching operation input by the user, a fourth window is displayed at a fifth moment T5. After the fourth window is displayed, the gradation of the electronic device changes to the second gradation L2 (for example, the gradation changes to the second gradation L2 at a moment T5' after the fourth moment T5).

At the fourth moment T4, the third window is a focus window. At the fifth moment T5, the focus window changes from the third window to the fourth window. The gradation of the electronic device is adjusted to the second gradation L2 based on a change of the focus window.

In other words, from the second moment T2 to the fourth moment T4, the focus window is stable in the second window. A process of adjusting the gradation from the second gradation L2 to the first gradation L1 may be implemented from the second moment T2 to the third moment T3. From the third moment T3 to the fourth moment, the gradation may be stable at the first gradation L1. Until the fourth moment T4, the focus window becomes the third window. At a moment T4' after the focus window changes to the third window, the gradation changes to the second gradation L2 again based on the change of the focus window. Then, the second gradation L2 is first adjusted to the third gradation adjustment L3 at the second duration K2 after the fourth moment T4. At the fifth moment T5 in a process of adjusting the third gradation L3 to the fourth gradation, the focus window changes to the fourth window. At the moment T4' after the focus window changes to the fourth window, the gradation changes to the second gradation L2 again based on the change of the focus window.

In some embodiments, after the gradation of the electronic device changes to the third gradation, a second timer may be set, where the second timer is configured to count a preset cycle time interval. In response to a third window switching operation input by the user, the fourth window is displayed at the fifth moment T5 within the preset cycle time interval. A window change notification is generated after the fifth moment. gradation adjustment of the third gradation L3 ends based on the window change notification.

For example, steps S601 to S616 may be performed from the fourth moment T4 to the fifth moment T5. For a specific implementation process, refer to the descriptions in steps S601 to S616. Details are not described herein again.

In some embodiments, after the second moment, the gradation of the electronic device is adjusted to the second gradation based on the change of the focus window and a fact that a power supply mode of the electronic device is a direct current power supply.

In some embodiments, the gradation of the electronic device is adjusted to the second gradation when a sleep exit event or a power-on event is detected. Specifically, refer to the descriptions in steps S211 to S213. Details are not described herein again.

In the gradation adjustment method provided in this embodiment of this application, after a window is switched, the gradation of the electronic device is first set to the second gradation. Then, the gradation is gradually adjusted from the second gradation to the first gradation. In this way, a problem in which screen flickering occurs when a focus window changes can be resolved, and power consumption of a display screen can be minimized. In addition, during gradation adjustment, if a new focus window change occurs, a gradation adjustment process based on a previous focus window change may be interrupted promptly.

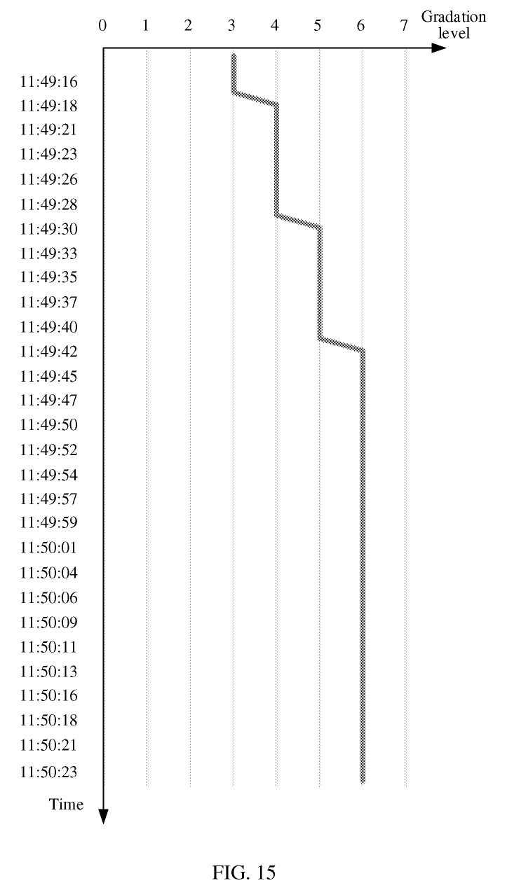

FIG. 15 is a diagram of reading, by using a tool PowerMax, a gradation level change of a gradation adjustment solution according to an embodiment of this application. FIG. 15 is gradation level change information of a local video captured in a full-screen mode for 15 minutes when a power supply mode is DC. As shown in FIG. 15, a gradation level of an electronic device increase from level 3 to level 6 stepwise, and steadily run at level 6. During increasing of the gradation level from level 3 to level 6 stepwise, the electronic device increases the gradation level by one level every 12s until the gradation level reaches level 6. In this way, because the gradation level is increased from level 3 to level 6 stepwise, no screen flickering occurs in this process. In addition, after the gradation level is increased to level 6, stable running at level 6 can minimize power consumed by a display screen.

The method embodiments described in this specification may each be an independent solution, or may be combined based on internal logic, and such solutions all fall within the protection scope of this application.

It may be understood that, in the foregoing method embodiments, the methods and operations implemented by the electronic device may also be implemented by a component (for example, a chip or a circuit) that can be used in the electronic device.

The gradation adjustment method provided in this application is described in the foregoing method embodiments. It may be understood that to implement the foregoing functions, the electronic device includes corresponding hardware structures and/or software modules for performing the functions. A person skilled in the art should easily be aware that, in combination with units and algorithm steps of the examples described in embodiments disclosed in this specification, this application can be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In an implementation process, steps in the foregoing methods can be completed by using a hardware integrated logical circuit in the processor, or by using instructions in the form of software. The steps of the method disclosed with reference to embodiments of this application may be directly performed and completed by a hardware processor, or may be performed and completed by a combination of hardware in the processor and a software module. The software module may be located in a mature storage medium in the art, such as a random access memory, a flash memory, a read-only memory, a programmable read-only memory, an electrically erasable programmable memory, or a register. The storage medium is located in the memory. The processor reads information in the memory and completes the steps of the methods in combination with hardware thereof. To avoid repetition, details are not described herein again.

It should be noted that, the processor in embodiments of this application may be an integrated circuit chip, and has a signal processing capability. In an implementation process, steps in the foregoing method embodiments can be implemented by using a hardware integrated logical circuit in the processor, or by using instructions in the form of software. The processor may be a general-purpose processor, a digital signal processor (DSP), an application-specific integrated circuit (ASIC), a field programmable gate array (FPGA) or another programmable logic device, a discrete gate or a transistor logic device, or a discrete hardware component, and the processor may implement or perform the methods, steps, and logical block diagrams that are disclosed in embodiments of this application. The general-purpose processor may be a microprocessor, or the processor may be any conventional processor or the like. The operations of the methods disclosed with reference to embodiments of this application may be directly performed and completed by using a hardware decoding processor, or may be performed and completed by using a combination of hardware and software modules in the decoding processor. The software module may be located in a mature storage medium in the art, such as a random access memory, a flash memory, a read-only memory, a programmable read-only memory, an electrically erasable programmable memory, or a register. The storage medium is located in the memory. The processor reads information in the memory and completes the steps of the methods in combination with hardware thereof.

It may be understood that the memory in this embodiment of this application may be a volatile memory or a nonvolatile memory, or may include a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM) that is used as an external cache. By way of example but not limitative descriptions, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM). It should be noted that the memories in the systems and methods described in this specification are intended to include but not limited to these memories and any memory of another appropriate type.

According to the method provided in embodiments of this application, an embodiment of this application further provides a computer program product. The computer program product includes a computer program or instructions. When the computer program or the instructions are run on a computer, the computer is caused to perform the method according to any one of the method embodiments.

According to the method provided in embodiments of this application, an embodiment of this application further provides a computer storage medium. The computer storage medium stores a computer program or instructions. When the computer program or instructions are run on a computer, the computer is caused to perform the method according to any one of the method embodiments.

According to the method provided in embodiments of this application, an embodiment of this application further provides an electronic device, including a memory and a processor. The memory is coupled to the processor, the memory is configured to store computer program code, the computer program code includes computer instructions, and when the processor executes the computer instructions, the electronic device is to perform the method according to any one of the method embodiments.

A person of ordinary skill in the art may be aware that, in combination with illustrative logical blocks described in embodiments disclosed in this specification and steps (step) may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

When the functions are implemented in the form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in embodiments of this application. The foregoing storage medium includes any medium that can store program code, such as a USB flash drive, a removable hard disk drive, a read-only memory (ROM), a random access memory (RAM), a magnetic disk, or an optical disc.

The computer storage medium, the computer program product, and the electronic device provided in embodiments of this application are all configured to perform the method provided above. Therefore, for beneficial effects that can be achieved by the computer storage medium, the computer program product, and the electronic device provided in embodiments of this application, refer to the beneficial effects corresponding to the method provided above. Details are not described herein again.

It should be understood that in embodiments of this application, an execution sequence of the steps should be determined based on functions and internal logic of the steps, and sequence numbers of steps do not mean an execution sequence, and do not limit an implementation process of embodiments.

The sections of this specification are all described in a progressive manner. For same or similar parts in embodiments, refer to these embodiments. Descriptions of each embodiment focus on a difference from other embodiments. In particular, embodiments of the apparatus, the computer storage medium, the computer program product, and the electronic device are basically similar to the method embodiments, and therefore are described relatively briefly. For related parts, refer to the descriptions in the method embodiments.

Although exemplary embodiments of this application have been described, a person skilled in the art who knows the basic inventive concept can make additional changes and modifications to these embodiments. Therefore, the following claims are intended to be construed as to cover the exemplary embodiments and all changes and modifications falling within the scope of this application.

The foregoing implementations of this application do not constitute a limitation on the protection scope of this application.

What is claimed is:

1. A gradation adjustment method, wherein the method is applied to an electronic device, and comprises:
displaying a first window at a first moment, wherein the first window is a focus window at the first moment, and a gradation of the electronic device at the first moment is a first gradation; and
setting a second window as a focus window at a second moment in response to a first operation input by a user, wherein the gradation of the electronic device is a second gradation after the second moment, the second gradation is lower than the first gradation, and the second moment is later than the first moment.

2. The method according to claim 1, wherein the method further comprises:
after the second window is set as the focus window, setting the gradation of the electronic device to the second gradation based on a change of the focus window.

3. The method according to claim 1, wherein the method further comprises:
setting the gradation of the electronic device to the first gradation at a third moment, wherein the third moment is later than the second moment.

4. The method according to claim 3, wherein before setting the gradation of the electronic device to the first gradation at the third moment, the method further comprises:
setting the gradation of the electronic device to a third gradation after the gradation of the electronic device being set to the second gradation and before the third moment, wherein the third gradation is lower than the first gradation and higher than the second gradation; and
setting the gradation of the electronic device to a fourth gradation after the gradation of the electronic device being set to the third gradation and before the third moment, wherein the fourth gradation is lower than the first gradation and higher than the third gradation.

5. The method according to claim 4, wherein the method further comprises:
setting a first timer after the second moment; and
setting the gradation of the electronic device to the third gradation comprises:
when elapsed time of the first timer reaches preset duration, setting the gradation of the electronic device to the third gradation based on a fact that the current second gradation of the electronic device is lower than the first gradation.

6. The method according to claim 4, wherein the method further comprises:
after the second moment, setting a display power saving technology DPST characteristic parameter to a first parameter and setting a first timer;
setting the DPST characteristic parameter to a second parameter when elapsed time of the first timer reaches preset duration, wherein the DPST characteristic parameter is set to the first parameter when the focus window changes;
setting the gradation of the electronic device to the third gradation comprises:
setting the gradation of the electronic device to the third gradation based on a fact that the DPST characteristic parameter is the second parameter and the current second gradation of the electronic device is lower than the first gradation; and
setting the gradation of the electronic device to the fourth gradation comprises:
setting the gradation of the electronic device to the fourth gradation based on a fact that the DPST characteristic parameter is the second parameter and the current third gradation of the electronic device is lower than the first gradation.

7. The method according to claim 4, wherein after setting the gradation of the electronic device to the third gradation, the method further comprises:
setting a second timer; and
setting the gradation of the electronic device to the fourth gradation comprises:
setting the gradation of the electronic device to the fourth gradation based on a fact that elapsed time of the second timer reaches a preset cycle time interval, no focus window change notification is detected within the preset cycle time interval, and the current third gradation of the electronic device is lower than the first gradation, wherein the focus window change notification is used for notifying the change of the focus window.

8. The method according to claim 5, before setting the first timer, further comprising:
based on a fact that there is a running first timer after the second moment, stopping the running first timer.

9. The method according to claim 3, wherein the method further comprises:
setting a third window as a focus window at a fourth moment in response to a second operation input by the user, wherein the gradation of the electronic device is the second gradation after the fourth moment, and the fourth moment is later than the third moment;
setting the gradation of the electronic device to a third gradation after the fourth moment, wherein the third gradation is lower than the first gradation and higher than the second gradation; and
after the gradation of the electronic device is set to the third gradation, setting the fourth window as a focus window at a fifth moment in response to a third operation input by the user, wherein the gradation of the electronic device is the second gradation after the fifth moment.

10. The method according to claim 9, wherein the method further comprises:
setting a second timer after the gradation of the electronic device is set to the third gradation;
generating a window change notification after the fifth moment; and
based on the window change notification and a fact that elapsed time of the second timer is within a preset cycle time interval , ending gradation adjustment after the gradation of the electronic device is set to the third gradation.

11. The method according to claim 1, wherein the method further comprises:
setting the gradation of the electronic device to the second gradation based on a sleep exit event or a power-on event.

12. The method according to claim 11, wherein the method further comprises:
setting the gradation of the electronic device to the first gradation after setting the gradation of the electronic device to the second gradation based on a sleep exit event or a power-on event.

13. The method according to claim 1, the method further comprises:
performing, brightness compensation processing on a first image based on the second gradation after the gradation of the electronic device becomes the second gradation;
displaying, the first image that has undergone the brightness compensation processing.

14. An electronic device, wherein the electronic device comprises a processor and a memory, the memory is coupled to the processor, the memory is configured to store computer program code, the computer program code comprises computer instructions, and when the processor executes the computer instructions, the electronic device is caused to perform:
displaying a first window at a first moment, wherein the first window is a focus window at the first moment, and a gradation of the electronic device at the first moment is a first gradation; and
setting a second window as a focus window at a second moment in response to a first operation input by a user, wherein the gradation of the electronic device is a second gradation after the second moment, the second gradation is lower than the first gradation, and the second moment is later than the first moment.

15. The electronic device according to claim 14, wherein when the processor executes the computer instructions, the electronic device is further enabled to perform:
after the second window is set as the focus window, setting the gradation of the electronic device to the second gradation based on a change of the focus window.

16. The electronic device according to claim 14, wherein when the processor executes the computer instructions, the electronic device is further enabled to perform:
setting the gradation of the electronic device to the first gradation at a third moment, wherein the third moment is later than the second moment.

17. The electronic device according to claim 16, wherein when the processor executes the computer instructions, the electronic device is further enabled to perform:
before setting the gradation of the electronic device to the first gradation at the third moment , setting the gradation of the electronic device to a third gradation after the gradation of the electronic device being set to the second gradation and before the third moment, wherein the third gradation is lower than the first gradation and higher than the second gradation; and
setting the gradation of the electronic device to a fourth gradation after the gradation of the electronic device being set to the third gradation and before the third moment, wherein the fourth gradation is lower than the first gradation and higher than the third gradation.

18. The method according to claim 16, wherein when the processor executes the computer instructions, the electronic device is further enabled to perform:
setting a third window as a focus window at a fourth moment in response to a second operation input by the user, wherein the gradation of the electronic device is the second gradation after the fourth moment, and the fourth moment is later than the third moment;
setting the gradation of the electronic device to a third gradation after the fourth moment, wherein the third gradation is lower than the first gradation and higher than the second gradation; and
after the gradation of the electronic device is set to the third gradation, setting the fourth window as a focus window at a fifth moment in response to a third operation input by the user, wherein the gradation of the electronic device is the second gradation after the fifth moment.

19. The method according to claim 14, wherein when the processor executes the computer instructions, the electronic device is further enabled to perform:
setting the gradation of the electronic device to the second gradation based on a sleep exit event or a power-on event.

20. A computer-readable storage medium, wherein the computer-readable storage medium stores a computer program or instructions, and when the computer program or the instructions are run on a computer, the computer is caused to perform:
displaying a first window at a first moment, wherein the first window is a focus window at the first moment, and a gradation of the electronic device at the first moment is a first gradation; and
setting a second window as a focus window at a second moment in response to a first operation input by a user, wherein the gradation of the electronic device is a second gradation after the second moment, the second gradation is lower than the first gradation, and the second moment is later than the first moment.
